(19) United States
(12) Patent Application Publication
(10) Pub. No.: US 2011/0148263 A1
(43) Pub. Date: Jun. 23, 2011

(54) HOUSING HAVING A BURGLAR-PROOF DOOR HINGE

(75) Inventor: Bernd Delakowitz, Berlin (DE)

(73) Assignee: ADC GMBH

(21) Appl. No.: 13/059,854

(22) PCT Filed: Jul. 23, 2009
(86) PCT No.: PCT/EP09/05353

§ 371 Date: Feb. 18, 2011

(30) Foreign Application Priority Data
Aug. 21, 2008 (DE) 10 2008 039 080.1

(51) Int. Cl. A47B 96/00; E05D 11/00

(52) U.S. Cl. 312/326

(57) ABSTRACT

The invention relates to a housing (1) for accommodating objects, comprising at least one door (5; 5-1, 5-2), which is mounted at one end (12) so as to be capable of pivoting about a pivot axis (10), at least two securing elements being provided, which engage in one another in the closed state and of which the one securing element is fastened or formed on the one end (12) of the door (5; 5-1, 5-2), and the other securing element is fastened or formed and is arranged in the pivoting region of the first securing element on another component part of the housing (1), with respect to which the door (5; 5-1, 5-2) is capable of pivoting, with the result that levering-open of the door (5; 5-1, 5-2) perpendicular to the pivot axis (10) relative to a component part or element of the housing (1), which is arranged adjacent to the door (5; 5-1, 5-2), in the closed state is suppressed or at least made more difficult as a result of a form-fitting connection between the securing elements.

The invention relates to a housing for accommodating objects, which comprises at least one door, which is mounted at one of its ends so as to be capable of rotating about a pivot axis. In particular, the invention relates to a door hinge for such a housing, which is provided with break-in protection.

The prior art has disclosed housings which are provided for accommodating objects. The objects which are accommodated are, for example, devices and/or assemblies or appliances of communications and/or supply networks. In particular, such housings are used in the telecommunications networks and/or other data networks sector in order to accommodate in particular electrical, electronic, optoelectronic and/or optical elements, appliances and devices.

A large number of the housings installed in public areas, in particular outdoors. One purpose of the housings is to protect the objects, devices etc. arranged in the interior from external effects. In particular, the objects arranged in the housing are intended to be protected from environmental influences such as damp, rain, wind, solar radiation, dust, heat, cold, but also external mechanical actions by and effects of objects, people and/or animals.

In order to be able to introduce the individual objects arranged in the interior of the housings into the housing and/or to be able to carry out maintenance work on them, modify them or the like, the housings generally have at least one door, which is mounted so as to be capable of rotating about a pivot axis. A pivot axis is understood below in each case to mean a possibly only virtually present axis, which fixes an axis of rotation of a pivoting movement of the door. At least sections of this pivot axis are generally also physical in nature. For example, two hinge pins may be provided in a housing which engage in the door on an upper side and on a lower side and about which the door is capable of rotating. In order to ensure access to the interior of the housing which is as good as possible, the hinge of the at least one door is often formed at a corner of the housing. A weak point of these housings consists in the fact that attackers with tools which they position in a gap between the door and a side wall cause a deformation of the door as a result of a levering movement with the tools which are supported against an adjoining wall face of the housing, for example the side wall, in a region between the hinge pins.

The invention is therefore based on the technical object of providing a housing which has improved protection against such attempted attacks in the region of the hinge of the at least one door.

The object is achieved according to the invention by a housing having the features of patent claim 1. Advantageous configurations of the invention result from the dependent claims.

In this case, it is provided that, in the case of a housing of the type mentioned at the outset, at least two securing elements are used which engage in one another in a form-fitting manner in a closed state of the door. At least one of the securing elements is fastened or formed on the one end of the door, on which the door is mounted so as to be capable of rotating about the pivot axis. At least one other of the securing elements is arranged in the pivoting region of the at least one of the securing elements, with the result that a levering-open of the door perpendicular to the pivot axis relative to a component part of the housing, which is arranged adjacent to the door, in the closed state is suppressed or at least made more difficult as a result of a form-fitting connection between the securing elements. As a result, form-fitting connections are provided in the hinge region in the closed state so as to prevent attacks which attempt to lever open the door perpendicular to the pivot axis for example in the direction of a front side of the door. One of the securing elements is pivoted with the door, while the other securing elements is fastened “fixed in position” on a component part of the housing.

In a preferred embodiment, the at least one other of the securing elements is formed or fastened on a component part which is arranged adjacent to the one end of the door.

The at least two securing elements are generally configured or formed differently. Preferably, the at least two securing elements comprise at least one tumbler with a cutout and at least one pin.

In this case, in one embodiment at least one tumbler (as the one securing element) is provided on the door, and this tumbler is connected to the door or formed in it and has a cutout. In a pivoting region of the at least one tumbler, a pin (as the other securing element) is provided, which pin engages in the at least one cutout of the at least one tumbler in a closed state of the door. In the other embodiments, the pin and the tumbler are fitted or formed in such a way that they are interchanged.

In a preferred embodiment, the at least one pin is aligned tangentially with respect to a circle segment, along which the pin itself or the corresponding at least one cutout of the at least one tumbler moves during opening and/or closing of the door.

A particularly stable embodiment of such a protected hinge is achieved if the pivot axis runs in the interior of the door. This means that the elements which partially materially form the pivot axis, for example the hinge pin, are protected from attacks by an outer side of the door.

A secure engagement of the at least one pin in the at least one cutout of the at least one tumbler is achieved if the at least one cutout is in the form of a through-hole. The at least one pin preferably has such a length that it protrudes through the through-hole in the closed state of the door.

In order to ensure secure engagement or penetration of the at least one pin into the at least one cutout even in the case of slight tolerances with respect to the movements of the door in a plane perpendicular to the pivot axis when the door is pivoted shut, the pin tapers at its tip. Preferably, the at least one pin is designed to be cylindrical and has a conical bevel at its tip. However, other embodiments can also provide pins with different geometric cross sections.

In a preferred embodiment, the component part arranged adjacent to the door is a side wall of the housing. A few embodiments therefore provide that the at least one pin is fastened on a side wall of the housing. Preferably, the pin is oriented perpendicular to an outer face of the side wall. Other embodiments provide that the securing element which is fastened or formed on the adjacent component part is a tumbler with a cutout. The cutout is preferably a through-hole. These embodiments are particularly advantageous in those embodiments in which the at least one door extends up to a corner of the housing and the hinge is located at the corner of the housing. As a result of the fact that the at least one pin or the at least one tumbler is fastened on a side wall, it is ensured that, during a levering movement, for the implementation of which a tool would be supported on the corresponding side wall in such a case, the door can neither move nor be substantially deformed relative to the at least one adjacent component part. In other embodiments, however, it can be provided that the securing element which is fastened or formed “fixed in position” on the housing is also fastened on another element of the housing.

Preferred housings are constructed in such a way that the side walls can be hung into a frame. When such a side wall is hung, a movement of the side wall in a direction parallel to the pivot axis of the door is often necessary. In order to make it possible to hang and/or remove such a side wall on which one of the securing elements is fastened or formed even in the closed state of the at least one door, in which the securing elements engage in one another, one embodiment provides that the at least one cutout is in the form of a slot.

Preferred embodiments of housings have doors whose outer face comprises a plate. This plate is usually bent a plurality of times and often forms a bent-back region at the one end, through which the pivot axis runs. The bent-back region forms a short door limb and the front side of the door forms a long door limb of the bent-back door.

In a preferred embodiment, the tumblers are in the form of T-shaped lugs, which are arranged through slits, preferably slits in an end side, which runs parallel to the front side of the door, of the short door limb. One limb of the T-shaped lug, which limb is sometimes also referred to as lug limb in order to distinguish it from the door limbs, has the cutout, which is preferably in the form of a through-hole and is designed to be parallel to the remaining limbs or lug limbs of the T-shaped lug.

Particularly preferred are embodiments which have a plurality of tumblers and correspondingly a plurality of pins. The tumblers can be fitted as individual lugs on the door and are in the form of T-shaped lugs, for example, whose one limb with the cutout is guided in each case through a slit of the door plate. The other limbs of the T-shaped lugs are, for example, welded, riveted, screwed or fixedly connected in another way to the plate of the door. Other embodiments provide that the plurality of tumblers are in the form of tabs of an elongated element, which tabs are guided, for example, likewise through slits in a plate of the door. Other embodiments can provide, however, that the tumblers are designed to be integral with the door or are screwed, riveted, welded or fastened fixedly in another way to the door.

In order to realize a pivoting region of the door which is as large as possible, even if a further door or a further housing is arranged next to the door, the door in an embodiment of the invention has a beveled corner face, which connects a front side of the door and a side face, which is, for example, an outer side of the short door limb in the case of a bent-back door, to one another. Preferably, the beveled corner face is chamfered through 45° with respect to the front side of the door. This means that, measured from the front side of the door to the beveled corner face on the outer side, an angle of 225° is covered. As a result, in the case of a door which forms or comprises a corner of the housing and whose pivot axis is in the interior of the housing, it is ensured that the door can be pivoted through a certain pivoting angle when it is opened without parts of the door protruding laterally out of the housing.

In order to be able to arrange in particular a plurality of housings next to one another and/or a plurality of doors next to one another, the doors and/or housings are preferably formed with beveled corner faces at their corners, preferably at all corners. In the case of doors and/or housings which directly adjoin one another, it is thus possible for a potential pivoting region of the doors to be enlarged.

In a few embodiments it is additionally provided that spacer elements are arranged or can be arranged between the adjacent doors or adjacent housings. As a result, even larger pivoting regions of the doors can be achieved. In a preferred embodiment, the pins are arranged on such a spacer element, which connects adjacent housings and/or housing parts to one another.

The invention will explained in more detail below with reference to figures, in which:

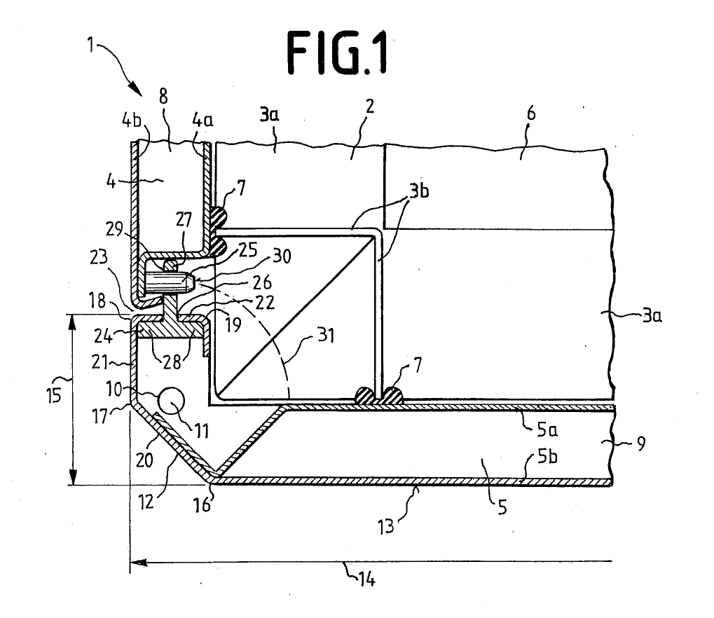

FIG. 1 shows a schematic sectional view through a corner of a housing with a closed door;

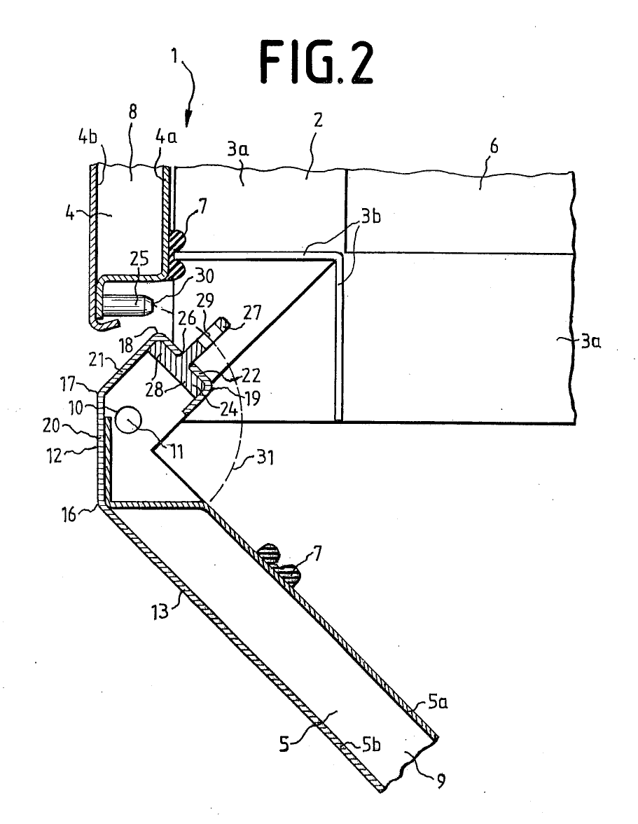

FIG. 2 shows a schematic sectional view similar to that in FIG. 1 in which the door is opened through an angle of 45°;

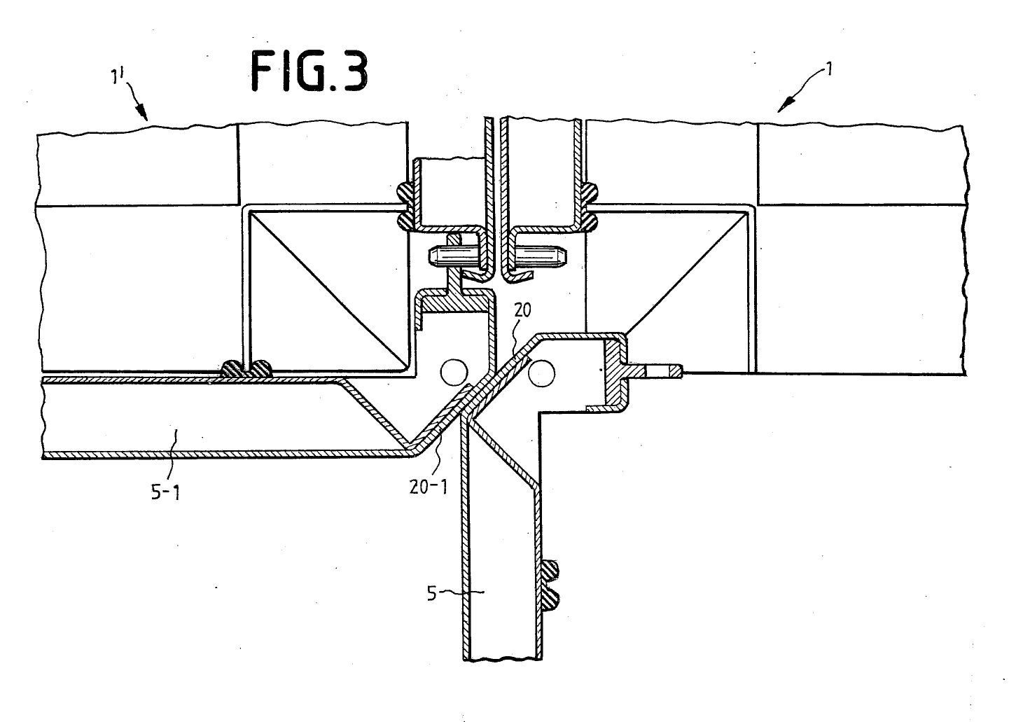

FIG. 3 shows a schematic view in which a door of a housing similar to that in FIG. 1 is opened through 90° and a further housing is arranged directly adjacent;

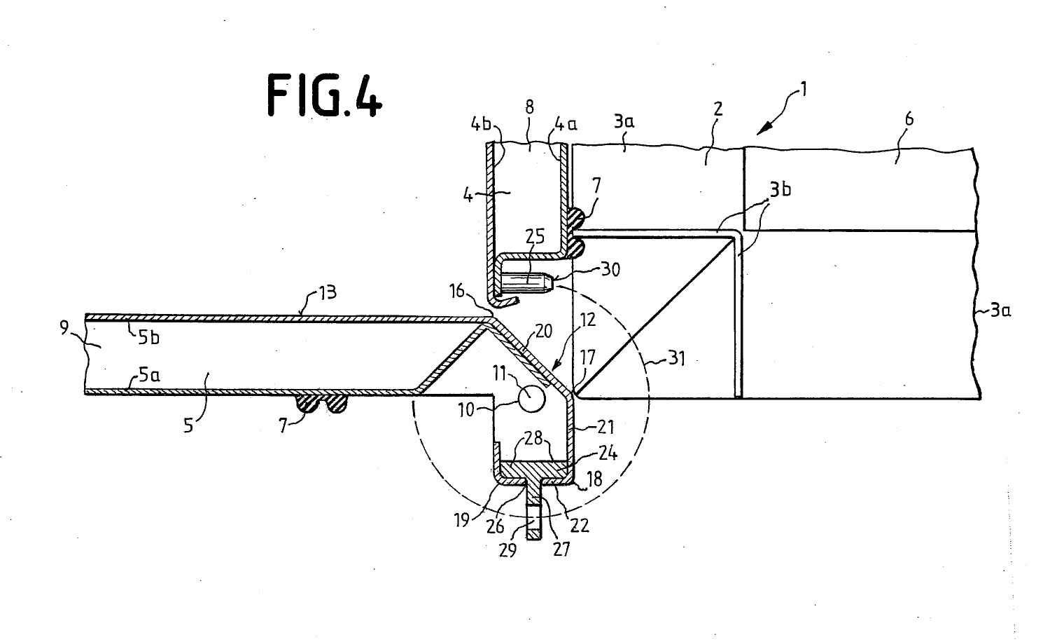

FIG. 4 shows a schematic view similar to that in FIG. 1, with the door being pivoted open through 180°; and

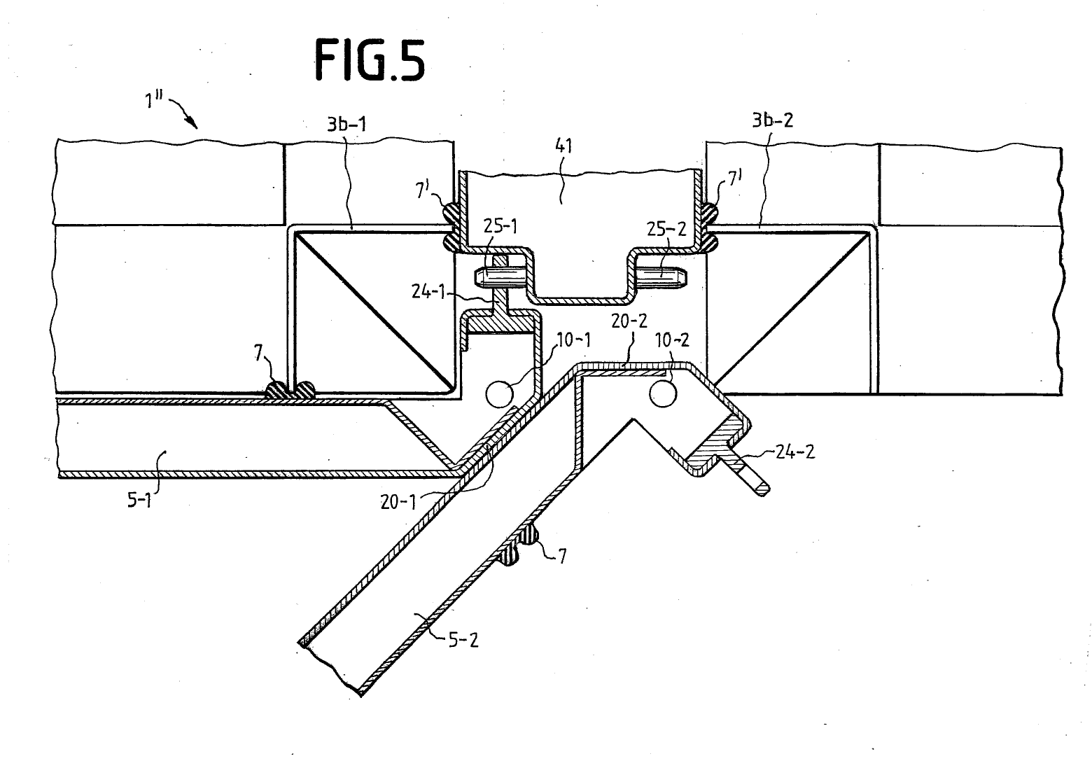

FIG. 5 shows a schematic cross-sectional view through part of a housing, which comprises a plurality of sections, which each have a door, a door of one section being open through an angle of 135°.

FIG. 1 schematically illustrates a cross-sectional view of a corner of a housing 1. The housing 1 comprises a housing frame 2, which preferably comprises housing profiles 3a, 3b which are fastened to one another. Said housing profiles are, for example, screwed to one another. However, they can also be connected to one another in any other desired manner. Surface elements, which delimit and surround an interior 6, are fastened on the housing frame 2. The interior 6 is provided in order to accommodate objects and/or appliances. The surface elements comprise, in the detail illustrated, a side wall 4 and a door 5. Generally, the interior 6 is additionally delimited on an upper side by a cover and/or roof element and at a base by a bottom plate and/or a pedestal.

In order to achieve hermetic sealing with respect to the environment, the individual surface elements are sealed off from one another and/or from the housing frame 2 by means of seals 7.

In order to make effective heat dissipation of heat produced in the interior 6 possible and at the same time to prevent an input of thermal energy in the form of solar radiation via the surface elements, said surface elements are preferably designed to have two walls. Both the side wall 4 and the door 5 each have an inner limit face 4a and 5a, respectively, and an outer limit face 4b and 5b, respectively. Between these, in each case one cavity 8, 9 is formed in which preferably air can circulate. Since a fluid exchange between the interior and the cavities 8, 9 through the inner limit faces 4a, 5a is not possible the inner limit faces are preferably produced from a thermally conductive material, for example a metal. The outer limit faces are also produced from a metal in preferred embodiments.

The door 5 is capable of rotating about a pivot axis 10, which runs perpendicular to the plane of the drawing and which runs through a center of a hinge pin 11. The hinge pin 11 extends perpendicular to the plane of the drawing, not along the entire door 5. Instead, there are two hinge pins 11, which, at an upper and a lower end of the door 5, engage therein with one end and are fastened on the housing frame 2 (or the roof element and/or pedestal) with their other end.

In the example illustrated, the door 5 is designed so as to be bent back at one end 12, on which it is mounted so as to be capable of rotating about the pivot axis 10. The door 5 has a long door limb 14, which surrounds the front side 13, and a short door limb 15. The pivot axis 10 runs through the interior of the door 5.

The outer limit face 5b of the door 5, which is also referred to as the outer wall of the door 5, is preferably in the form of a plate, which has a plurality of bending edges 16-19, which run perpendicular to the plane of the drawing. The outer limit face 5b thus forms the front side 13, a beveled corner face 20, a side face 21 of the short door limb 15 and an end face 22 of the short door limb 15.

In order to protect the door 5 or the housing 1 against attacks in which tools are introduced into a gap 23 which is unavoidably formed between the door 5 and the side wall 4 in order to lever the door 5 and the side wall apart from one another, at least one tumbler is fastened on the door 5 and correspondingly a pin 25 on the side wall. The tumbler 24 comprises a T-shaped lug, which is guided through a slit 26, which is formed in the end face 22 of the short door limb 15 of the door 5. In this case, a long limb 27 of the tumbler 24 protrudes through the slit 26, while two short limbs 28 of the tumbler 24 bear against an inner side of the end face 22 of the outer limit face 5b of the door 5. The T-shaped tumbler 24 increases the stability of the end face 22 of the door. The long limb 27 of the tumbler 24 has a cutout 29, which is in the form of a through-hole and through which the pin 25, which is preferably cylindrical, protrudes in the closed state of the door 5. The pin 25 is slightly tapered at a tip 30. The pin 25 is aligned tangentially with respect to a circle segment 31, along which the cutout 29 moves, while the door 5 is pivoted open. The through-hole of the cutout 29 can in some embodiments be in the form of a slot, which extends perpendicular to the plane of the drawing, in order to be able to hang and remove the side wall 4 in and from the housing 1 via a movement running perpendicular to the plane of the drawing, while the door 5 is closed.

In the closed state, the pin 25 and the tumbler 24 form a form-fitting connection between the door 5 and the side wall 4. An attack with a tool at the gap 23 with the aim of levering the door 5 and the side wall 4 apart from one another can therefore be successfully prevented.

In a preferred embodiment, a plurality of tumblers and pins are provided spaced apart from one another perpendicular to the plane of the drawing. Other embodiments provide an elongated element with a plurality of tabs, which form the tumblers and are guided through a plurality of slits, which are separate from one another, in the end face 22 of the door 5.

FIG. 2 is again a schematic illustration of the housing 1 shown in FIG. 1, with the door 5 being pivoted open through an angle of 45°. In all of the drawings, the same technical features are denoted by identical reference symbols. It can be seen that the cutout 29 has moved along the circle segment 31 and, in the open state, the pin 25 is no longer in engagement with the tumbler 24. It can clearly be seen that the housing profile 3b extending perpendicular to the plane of the drawing is in the form of an angled profile and as a result leaves sufficient space free for the pivoting of the tumbler 24 and the short door limb 15.

FIG. 3 is a schematic illustration of a housing 1 similar to that in FIGS. 1 and 2, which housing is arranged adjacent to a further housing 1′. The further housing 1′ has a further door 5-1, which is fixed correspondingly in mirror-image fashion with respect to the door 5 of the housing 1. The further door 5-1 also has a beveled corner face 20-1. As a result, it is possible to open either the door 5 or the further door 5-1 in each case up to an opening angle of 90°.

If no further housing is arranged next to the housing 1, the door 5 can even open up to an opening angle of 180°, as is illustrated in FIG. 4.

FIG. 5 is a schematic illustration of a housing 1″, which has a plurality of doors 5-1, 5-2, which are fixed in mirror-image fashion with respect to one another. In this embodiment, in which housing profile elements 3b-1, 3b-2 represent parts of the inner limit face of the interior, a connecting frame 41 is arranged between them, which connecting frame is connected to the housing profiles 3b-1, 3b-2 in such a way that it is sealed off via seals 7′. In this embodiment, pins 25-1, 25-2 are fastened on the connecting frame 41 and engage in the tumblers 24-1, 24-2 or the cutouts 29-1, 29-2 thereof. If the angles of the beveled corner faces 20-1, 20-2 and a width of the connecting frame 41, i.e. a distance between the axes of rotation 10-1, 10-2, are selected so as to match one another correspondingly, in this embodiment, in which the beveled corner face 20-2 has a 45° chamfer with respect to the front side 15-2, it is in each case possible for pivoting to take place alternatively through 135° during opening. Such a connecting frame 41 is generally also referred to as a spacer element.

The embodiments illustrated are merely exemplary configurations. Corresponding spacer elements can also be provided between separately formed housings in order to make possible or ensure opening of the doors through a predetermined angle, which is matched to an angle of the beveled corner faces.

In other embodiments, the one or more tumblers can be designed to be integral with an outer face of the door. In an embodiment similar to that in FIG. 1, a projecting lug could be formed, for example, by means of three additional bending edges being introduced between the bending edges 18 and 19 in the end face 22, which projecting lug would be formed substantially parallel to the side face 22 of the short door limb 15 of the bent-back door 5. One or more bores introduced herein would provide the cutouts into which the pin(s) 25, which is/are fastened on the side wall 4, would engage.

Other embodiments can provide that the tumblers are fastened or formed on the side wall or are fastened on another element of the housing and the pins are fastened on a door and are aligned tangentially with respect to a circle element, on which the pins move in each case during pivoting of the door. In such a case, a pivoting pin engages in a cutout of a tumbler which is arranged fixed in position on the housing.

### LIST OF REFERENCE SYMBOLS

1, 1′, 1″ Housing
2 Housing frame
3a, 3b Housing profiles
3b-1, 3b-2 Housing profiles
4 Side wall
4a Inner limit face
4b Outer limit face
5 Door
5-1, 5-2 Door
5a Inner limit face
5b Outer limit face
6 Interior
8, 9 Cavities
10, 10-1, 10-2 Pivot axis
11 Hinge pin
12 End
13 Front side
14 Long door limb of a bent-back door
15, 15-1, 15-2 Short door limb of a bent-back door
16 to 19 Bending edges
20, 20-1, 20-2 Beveled corner face
21 Side face of the short door limb of a bent-back door
22 End face of the short door limb of a bent-back door
23 Gap
24, 24-1, 24-2 Tumbler (one securing element)
25, 25-1, 25-2 Pin (another securing element)
26 Slit
27 Long limb of a T-shaped tumbler
28 Short limb of a T-shaped tumbler
29, 29-1, 29-2 Cutout
30 Tip
31 Circle segment
41 Connecting frame

1. A housing for accommodating objects, comprising at least one door, which is mounted at one end so as to be capable of pivoting about a pivot axis, wherein at least two securing elements are provided, which engage in one another in the closed state and of which the at least one of the securing elements is fastened or formed on the one end of the door and the at least one other of the securing elements is arranged in the pivoting region of the at least one of the securing elements, open with the result that a levering-open of the door perpendicular to the pivot axis relative to a component part of the housing, which is arranged adjacent to the door, in the closed state is suppressed or at least made more difficult as a result of a form-fitting connection between the securing elements.

2. The housing as claimed in claim 1, wherein the at least one other of the securing elements is formed or fastened on a component part which is arranged adjacent to the one end of the door.

3. The housing as claimed in claim 1, wherein the at least two securing elements comprise at least one tumbler with a cutout and at least one pin.

4. The housing as claimed in claim 3, wherein the at least one pin is aligned tangentially with respect to a circle segment, along which the at least one pin itself or the corresponding at least one cutout moves during opening and/or closing of the door.

5. The housing as claimed claim 1, wherein the pivot axis runs in the interior of the door.

6. The housing as claimed claim 1, wherein the at least one cutout is a through-hole.

7. The housing as claimed in claim 1, wherein the at least one pin is fastened on a side wall of the housing and is oriented perpendicular to an outer face of the side wall.

8. The housing as claimed in claim 1, wherein the door is bent back at least at the one end, the door preferably having a beveled corner face instead of a corner point, at which a side face of a short, bent-back door limb and a front side of the door, which forms an outer side of a long door limb, would insect one another.

9. The housing as claimed in claim 1, wherein outer corners of the housing cross section are beveled at least on the side in which the at least one door is arranged.

10. The housing as claimed in claim 1, wherein the beveled corner face is chamfered at 45° with respect to a front side of the door.

11. The housing as claimed in claim 1, wherein the through-hole is a slot.

12. The housing as claimed in claim 1, wherein a plurality of pins which are spaced apart from one another are provided parallel to the pivot axis, and correspondingly a plurality of cutouts are formed in the at least one tumbler and/or further tumblers with corresponding cutouts are fastened on the door.

13. The housing as claimed in claim 1, wherein the at least one tumbler is a T-shaped lug, whose one limb has the cutout which runs parallel to the two remaining limbs, the one limb being guided through a slit of an outer face of the door.

14. The housing as claimed in claim 1, wherein an outer face of the door comprises a plate, which has a plurality of bends at the one end in order to form the beveled corner face and/or the bent-back portion at the one end.

15. The housing as claimed in claim 1, wherein the at least one tumbler and possibly further tumblers are formed as tabs with through-holes, which are each guided through slits in the outer face of the door.

16. The housing as claimed in claim 1, wherein the at least one tumbler is arranged on an end side of the short door limb of the bent-back region of the door on the one end, the end side being oriented parallel to a front side of the door.

17. The housing as claimed in claim 1, wherein a side face of the bent-back region on the one end of the door is aligned flush with a side wall of the housing.

18. The housing as claimed in claim 1, wherein a spacer element is arranged or can be arranged between adjacent doors of the housing and/or a door and a door of a further housing, in each case one of the securing elements, preferably the at least one pin, being arranged or formed on the spacer element.
